(19) United States
(12) Patent Application Publication
(10) Pub. No.: US 2022/0336843 A1
(43) Pub. Date: Oct. 20, 2022

(54) HONEYCOMB TYPE LITHIUM ION BATTERY

(71) Applicant: TOYOTA JIDOSHA KABUSHIKI KAISHA, Toyota-shi (JP)

(72) Inventor: Masaharu SENOUE, Seto-shi (JP)

(21) Appl. No.: 17/658,027

(22) Filed: Apr. 5, 2022

(30) Foreign Application Priority Data
Apr. 15, 2021 (JP) 2021-069191

(51) Int. Cl. H01M 10/0525; H01M 10/42

(52) U.S. Cl. CPC H01M 10/0525; H01M 10/4235; H01M 2004/021

(57) ABSTRACT

Provided is a honeycomb type lithium ion battery that makes it possible to suppress a short circuit. The honeycomb type lithium ion battery has an anode, a cathode, and a separator layer, wherein the anode has a plurality of through holes extending in one direction, the separator layer has Li ion permeability, and physically isolates the anode and the cathode from each other, at least inner walls of the through holes being covered with the separator layer, the cathode is disposed at least inside the through holes via the separator layer, the separator layer has a first layer with which the inner walls of the through holes are covered, and a second layer disposed between the first layer and the cathode, and the solubility of a binder contained in the first layer is lower than that contained in the second layer.

### FIELD

The present application relates to a honeycomb type lithium ion battery.

### BACKGROUND

Patent Literature 1 discloses: a honeycomb-structure current collector for an electrode of a lithium ion secondary battery which is formed by coating, with a titanium nitride film, the surfaces of partitions of cells which include the outer surface of a carbonaceous honeycomb structure; and an electrode of a lithium ion secondary battery which is formed by filling the cells of this current collector with an active material for a cathode or an anode.

### CITATION LIST

### Patent Literature

Patent Literature 1: JP 2001-126736 A

### SUMMARY

### Technical Problem

As a result of his intensive research on a honeycomb type lithium ion battery, the inventor of the present application found out that when a separator is disposed inside through holes of an anode having a honeycomb structure, next a cathode paste is disposed in the through holes, and thereafter a solvent in the cathode paste is dried, shrinkage stress of a binder that is contained in the cathode paste applies tensile stress to the separator, which may cause cracks in the battery. The inventor also found out that such cracks may cause the cathode and the anode to be in contact with each other to short-circuit.

In view of the above circumstances, an object of the present disclosure is to provide a honeycomb type lithium ion battery that makes it possible to suppress a short circuit.

### Solution to Problem

As one aspect to solve the above problem, the present disclosure is provided with a honeycomb type lithium ion battery having an anode, a cathode, and a separator layer, wherein the anode has a plurality of through holes extending in one direction, the separator layer has Li ion permeability, and physically isolates the anode and the cathode from each other, at least inner walls of the through holes being covered with the separator layer, the cathode is disposed at least inside the through holes via the separator layer, the separator layer has a first layer with which the inner walls of the through holes are covered, and a second layer disposed between the first layer and the cathode, and solubility of a binder contained in the first layer, in a solvent used when the cathode is disposed in the through holes is lower than that contained in the second layer.

### Advantageous Effects

In the honeycomb type lithium ion battery according to the present disclosure, the separator layer disposed inside the through holes of the anode has a two-layer structure including the first layer and the second layer. One feature of the honeycomb type lithium ion battery according to the present disclosure is that the solubility of a binder contained in the first layer, in a solvent (cathode solvent) used when the cathode is disposed in the through holes is lower than that contained in the second layer.

The second layer having such a configuration is easier to soften with a cathode solvent than the first layer, when the cathode is disposed in the through holes. Accordingly, the second layer makes it possible to relax shrinkage stress due to the binder contained in the cathode, more than the first layer, in drying after the cathode is disposed. The relaxed shrinkage stress can lead to suppression of cracks and thus suppression of a short circuit.

The first layer is stabler against a cathode solvent than the second layer since the solubility of the binder in the first layer, in the cathode solvent is lower than that in the second layer. Therefore, the first layer makes it possible to suppress the softening with the cathode solvent, more than the second layer. The suppression of the softening results in suppression of pin holes etc. that are caused by the softening, and thus a short circuit caused by pin holes etc. can be also suppressed.

### BRIEF DESCRIPTION OF DRAWINGS

FIG. 1 is a perspective view of an anode 10;

FIG. 2 is a schematic cross-sectional view of a honeycomb type lithium ion battery 100;

FIG. 3 is a view focusing on one through hole 11;

FIG. 4 is photographs of a cracked honeycomb type lithium ion battery;

FIG. 5 is a flowchart of a method 1000 of manufacturing a honeycomb type lithium ion battery; and

FIG. 6 is a photograph (left) of a state where through holes are covered with first layers, and a photograph (right) of a state where the through holes are further covered with second layers.

### DESCRIPTION OF EMBODIMENTS

### Honeycomb Type Lithium Ion Battery

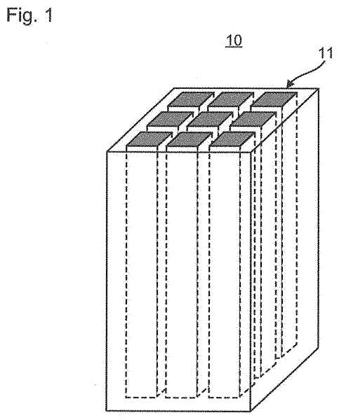

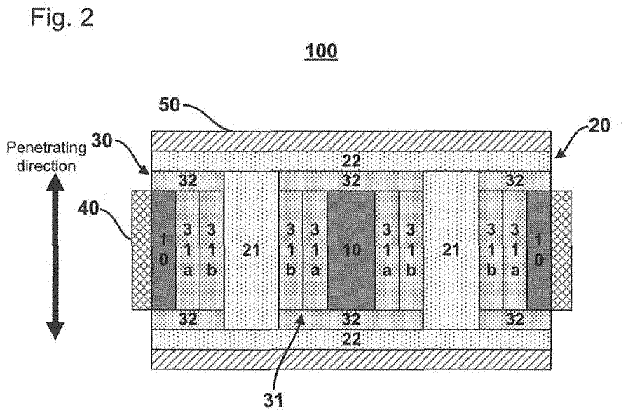

A honeycomb type lithium ion battery according to the present disclosure will be described as reference is made to a honeycomb type lithium ion battery 100 that is one embodiment (hereinafter may be referred to as “battery 100”). FIG. 1 is a perspective view of an anode 10. FIG. 2 is a schematic cross-sectional view of the battery 100 taken along the penetrating direction of through holes 11 of the anode 10.

As in FIG. 2, the battery 100 includes the anode 10, a cathode 20 and a separator layer 30. The battery 100 may be also provided with an anode current collector 40 and a cathode current collector 50.

<Anode 10>

The anode 10 has a plurality of the through holes 11 extending in one direction (penetrating direction). Such a structure is called a so-called honeycomb structure. The entire shape of the anode 10 is not particularly limited, but may be a quadrangular prism as in FIG. 1, any other prism, or a cylinder. The entire size of the anode 10 is not particularly limited, but may be suitably set according to the purpose. For example, the height of the anode 10 (length in the penetrating direction, h) may be 3 mm to 100 mm in view of improving strength. The diameter (d) of the anode 10 may be 10 mm to 100 mm. Further, the aspect ratio (h/d) of the height (h) to the diameter (d) of the anode 10 may be 0.1 to 10.

The shape of each of the through holes 11 provided in the anode 10 is not particularly limited. For example, a cross section of the through hole 11 which is orthogonal to the penetrating direction may have a circular shape, or a polygonal shape such as a regular hexagon. The hole diameter of the through hole 11 is not particularly limited as long as the cathode 20 and the separator layer 30 can be disposed inside the through hole 11. The hole diameter is, e.g., in the range of 10 μm and 1000 μm. The hole diameter means the maximum diameter. The area of the cross section of the through hole 11 is not particularly limited, but may be 900 μm² to 490000 μm². There are no particular limitations to a space (rib thickness) between any adjacent through holes 11 as long as the ribs can have such strength that the through holes 11 are supported. For example, the space ranges from 20 μm to 350 μm. The through holes 11 may be randomly arranged in the anode 10. In view of securing the filling volume of the cathode 20 to improve the capacity, the through holes 11 are preferably formed as regularly aligned as in FIG. 1.

The anode 10 contains an anode active material. Examples of the anode active material include carbon-based anode active materials such as graphite, graphitizable carbons, and nongraphitizable carbons, and alloy-based anode active materials containing silicon (Si), tin (Sn), or the like. The mean particle diameter of the anode active material is, for example, in the range of 5 μm and 50 μm. The anode 10 contains the anode active material in the range of, for example, 50 wt % and 99 wt %.

Here, in this description, the “mean particle diameter” is a particle diameter at the integrated value of 50% (median diameter) in a volume-based particle diameter distribution that is measured using a laser diffraction and scattering method.

The anode 10 may optionally contain a binder. Examples of the binder include carboxymethyl cellulose; rubber-based binders such as butadiene rubber, hydrogenated butadiene rubber, styrene-butadiene rubber (SBR), hydrogenated styrene-butadiene rubber, nitrile butadiene rubber, hydrogenated nitrile butadiene rubber and ethylene propylene rubber; fluoride-based binders such as polyvinylidene fluoride (PVDF), polyvinylidene fluoride-polyhexafluoropropylene copolymer (PVDF-HFP), polytetrafluoroethylene (PTFE), and fluororubber; polyolefin-based thermoplastic resins such as polyethylene, polypropylene, and polystyrene; imide-based resins such as polyimide, and polyamideimide; amide-based resins such as polyamide; acrylic resins such as polymethylacrylate, and polyethylacrylate; and methacrylic resins such as polymethyl methacrylate, and polyethyl methacrylate. The anode 10 contains the binder in the range of, for example, 0.1 wt % and 10 wt %.

The anode 10 may optionally contain a conductive aid. Examples of the conductive aid include carbon materials and metallic materials. Examples of the carbon materials include particulate carbonaceous materials such as acetylene black (AB), and Ketjenblack (KB); carbon fibers such as VGCF; and fibrous carbon materials such as carbon nanotubes (CNTs), and carbon nanofibers (CNFs). Examples of the metallic materials include Ni, Cu, Fe and SUS. The metallic materials are preferably particulate or fibrous. The anode 10 contains the conductive aid in the range of, for example, 0.1 wt % and 10 wt %.

<Separator Layer 30>

The separator layer 30 has Li ion permeability, and physically isolates the anode 10 and the cathode 20. The separator layer 30 may be a porous film in view of securing ion permeability. At least inner walls of the through holes 11 are covered with the separator layer 30.

In the battery 100 according to one embodiment, the separator layer 30 has partition separator layers 31 with which the inner walls of the through holes 11 are covered, and insulating film separator layers 32 with which at least one of opening face parts on one and the other sides of the anode 10 (faces in the penetrating direction) is covered. In FIG. 2, both the opening face parts of the anode 10 are covered with the insulating film separator layers 32.

The partition separator layers 31 physically isolate the inner walls of the through holes 11 and inner areas 21 of the cathode 20 which will be described later. The partition separator layers 31 contain an inorganic fine particle such as aluminum oxides/hydroxides, boehmite, titania, magnesia, and zirconia, preferably aluminum oxides/hydroxides, and boehmite. The mean particle size of the inorganic fine particle is, for example, in the range of 10 nm and 50 μm. The partition separator layers 31 contain the inorganic fine particle, for example, in the range of 20 wt % and 99 wt %. The partition separator layers 31 also contain a binder. A binder that may be contained in the partition separator layers 31, a content thereof, etc. will be described later.

The insulating film separator layers 32 physically isolate the opening face parts of the anode 10 and surface areas 22 of the cathode 10 which will be described later. The thickness of each of the insulating film separator layers 32 is not particularly limited, but for example, is in the range of 10 μm and 1000 μm. The material of the insulating film separator layers 32 includes an inorganic fine particle. The insulating film separator layers 32 contain the inorganic fine particle, for example, in the range of 20 wt % and 99 wt %. The insulating film separator layers 32 may also contain a binder. A binder that may be contained in the insulating film separator layers 32, a content thereof, etc. may be suitably selected from the binders that may be used in the anode 10, and the contents thereof.

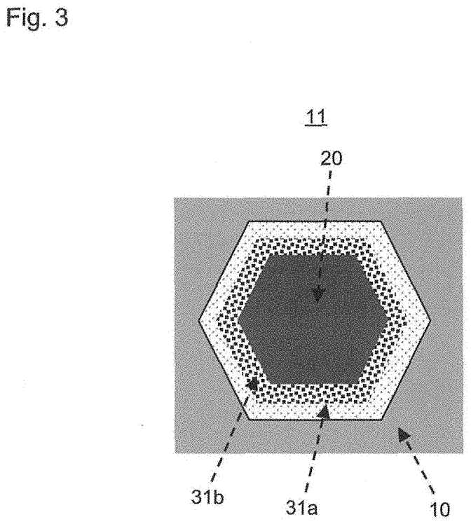

Here, the partition separator layers 31A have first layers 31a with which the inner walls of the through holes 11 are covered respectively, and second layers 31b disposed between the first layers 31a and the cathode 20 (inner areas 21 described later). That is, the partition separator layers 31 have a two-layer structure including the first layer 31a and the second layer 31b. FIG. 3 is a view focusing on one of the through holes 11. In FIG. 3, the through hole 11 of a regular hexagonal shape is used.

One feature of the present disclosure is that the solubility of the binder contained in the first layers 31a, in a solvent (cathode solvent) used when the cathode 20 is disposed in the through holes 11 is lower than that contained in the second layers 31b. “A solvent used when the cathode 20 is disposed in the through holes 11” is a solvent for mixing with a material that is to constitute the cathode, to prepare a paste. Such a solvent is not particularly limited, but for example, is NMP (N-methylpyrrolidone) or water, preferably NMP. A specific way of disposing the cathode 20 will be described in the paragraphs on a manufacturing method later.

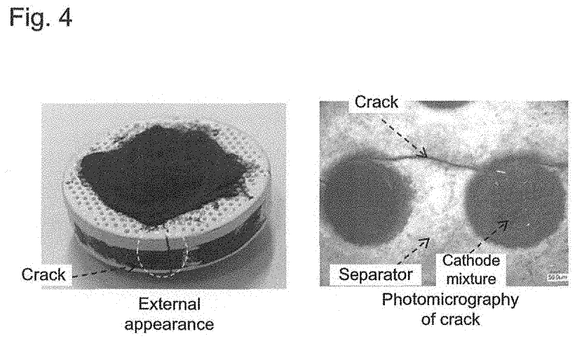

The second layers 31b having such a configuration are easier to soften with the cathode solvent than the first layers 31a, when the cathode 20 is disposed in the through holes 11. Accordingly, the second layers 31b make it possible to relax shrinkage stress due to the binder contained in the cathode 20, more than the first layers 31a, in drying after the cathode is disposed. The relaxed shrinkage stress can lead to suppression of cracks and thus suppression of contact (a short circuit) between the cathode and the anode. FIG. 4 is photographs of a cracked honeycomb type lithium ion battery for reference.

The first layers 31a are stabler against the cathode solvent than the second layers 31b since the solubility of the binder in the first layers 31a, in the cathode solvent is lower than that in the second layers 31b. Therefore, the first layers 31a make it possible to suppress the softening with the cathode solvent, more than the second layers 31b. The suppression of the softening results in suppression of pin holes etc. which are caused by the softening, and thus contact (a short circuit) between the cathode and the anode caused by pin holes etc. can be also suppressed.

A binder hardly soluble in the cathode solvent is used for the binder contained in the first layers 31a. A binder easily soluble in the cathode solvent is used for the binder contained in the second layers 31b. Whether the binder contained in the first layers 31a or the second layers 31b is hardly or easily soluble in the cathode solvent is determined by the following method.

A paste is prepared by mixing of a material (including a binder) to constitute the first layers 31a or the second layers 31b with a suitable solvent (e.g., NMP, water, or the like). The prepared paste is applied onto aluminum foil with a bar coater so as to have a thickness of 50 μm, and dried at 120° C. for 30 minutes. Next, two or three drops of the cathode solvent are put on the formed applied film to be left to stand for a predetermined time. After left to stand, the applied film is wiped off with a cotton swab. At this time, if the applied film peels off so that the aluminum foil is visible, it can be determined that the binder used in this test is easily soluble in the cathode solvent. For example, when NMP is used as the cathode solvent, the time during which NMP is left to stand after dropped on the applied film is 10 minutes.

When NMP is used as the cathode solvent, the major constituent of the binder contained in the first layers 31a may be polyethylene (PE) or polypropylene (PP), and the major constituent of the binder contained in the second layers 31b may be polyvinylidene fluoride (PVDF). The “major constituent” is a no less than 50 wt %, preferably no less than 70 wt %, more preferably no less than 90 wt %, further preferably no less than 95 wt %, and particularly preferably 100 wt % binder in the total binder contained in the first layers 31a or the second layers 31b. A binder other than the major constituent which may be contained in the first layers 31a or the second layers 31b may be suitably selected from the binders that may be used in the anode 10.

When water is used as the cathode solvent, the major constituent of the binder contained in the first layers 31a may be polyethylene, polypropylene, PVDF, polyimide, or the like, and the major constituent of the binder contained in the second layers 31b may be a binder to which a hydrophilic group is given. The “binder to which a hydrophilic group is given” is, for example, a binder formed by giving a skeleton including a hydrophilic group such as an amino group and a carboxyl group to PVDF, or a polyamic acid that is a raw material of polyimide.

The volume ratio of the binder to the inorganic fine particle (binder/inorganic fine particle) in the first layers 31a may range from 0.05 to 18. The volume ratio of the binder to the inorganic fine particle (binder/inorganic fine particle) in the second layers 31b may range from 0.05 to 1.73. The volume ratios of the binders to the inorganic fine particles in the respective layers lower than the lower limits of the above ranges make it difficult to retain the shape as the separator. The volume ratios of the binders to the inorganic fine particles in the respective layers higher than the lower limits of the above ranges lead to increased resistance of the battery. Here, one may convert the ratio of the raw materials of the inorganic fine particle and the binder into the volume ratio, to calculate the above described volume ratio.

The binder contained in the second layers 31b is easily soluble in the cathode solvent, which easily leads to filled pores of the separator, and thus increased resistance of the battery. Therefore, the upper limit of the range of the volume ratio in the second layers 31b is lower than that in the first layers 31a.

The thicknesses of the first layer 31a and the second layer are not particularly limited, but each range from, for example, 10 μm to 100 μm.

<Cathode 20>

The cathode 20 is disposed at least inside the through holes via the separator layer 30. In the battery 100 according to one embodiment, the cathode 20 has the inner areas 21 disposed inside the through holes 11 via the partition separator layers 31, and the surface areas 22, with which the opening face parts of the anode 10, which are covered with the insulating film separator layers 32, are covered.

The cathode 20 contains a cathode active material. Examples of the cathode active material include lithium cobaltate, lithium nickelate, lithium manganate, lithium nickel cobalt manganates, lithium nickel cobalt aluminates, and lithium iron phosphate. The mean particle size of the cathode active material is, for example, in the range of 5 μm and 100 μm. The cathode 20 contains the cathode active material, for example, in the range of 50 wt % and 99 wt %.

The cathode 20 contains a binder. As the binder, any binder that may be used in the anode 10 may be selected. For example, when NMP is used as the cathode solvent, PVDF may be used as the binder. The cathode 20 contains the binder in the range of, for example, 0.1 wt % and 10 wt %.

The cathode 20 may contain a conductive aid. The conductive aid and the content thereof may be suitably selected from the conductive aids that may be used in the anode 10, and the contents thereof.

The inner areas 21 are areas of the cathode 20 which fill the through holes 11, with which the partition separator layers 31 are covered. The surface areas 22 are areas of the cathode 10 with which the opening face parts of the anode 10, with which the insulating film separator layers 32 are covered, are covered. The thickness of each of the surface areas 22 is not particularly limited, but for example, is in the range of 10 μm and 1000 μm.

<Anode Current Collector 40>

The battery 100 may be provided with the anode current collector 40. For example, the anode current collector 40 is disposed on a side face of the anode 10. Examples of the material of the anode current collector 40 include SUS, Cu, Al, Ni, Fe, Ti, Co, and Zn.

<Cathode Current Collector 50>

The battery 100 may be provided with the cathode current collector 50. The cathode current collector 50 is disposed on the cathode 20. In FIG. 2, the cathode current collectors 50 are connected to the surface areas disposed on the faces of the battery 100 in the penetrating direction. Examples of the material of the cathode current collector 50 include SUS, Cu, Al, Ni, Fe, Ti, Co, and Zn.

<Electrolytic Solution>

An electrolytic solution may be used for the battery 100. When used, an electrolytic solution is injected all over the inside of the electrode body (specifically, all the pores of the anode 10, the cathode 20, and the separator layer 30). As the electrolytic solution, desirably, a nonaqueous electrolyte containing a lithium salt is a major constituent. Examples of the nonaqueous electrolyte include ethylene carbonate (EC), diethyl carbonate (DEC), dimethyl carbonate (DMC), and ethyl methyl carbonate (EMC). One of them may be used alone, or they may be used in combination. Examples of the lithium salt include LiPF6 and LiBF₄. The concentration of the lithium salt in the electrolytic solution may be, for example, 0.005 mol/kg to 2 mol/kg.

The honeycomb type lithium ion battery according to the present disclosure has been described using the honeycomb type lithium ion battery 100, which is one embodiment. The honeycomb type lithium ion battery according to the present disclosure including the predetermined separator layer 30 having a two-layer structure (partition separator layers 31) makes it possible to suppress a short circuit.

### Method of Manufacturing Honeycomb Type Lithium Ion Battery

Next, a method of manufacturing a honeycomb type lithium ion battery according to the present disclosure will be described as reference is made to a method 1000 of manufacturing a honeycomb type lithium ion battery which is one embodiment (hereinafter may be referred to as “manufacturing method 1000”).

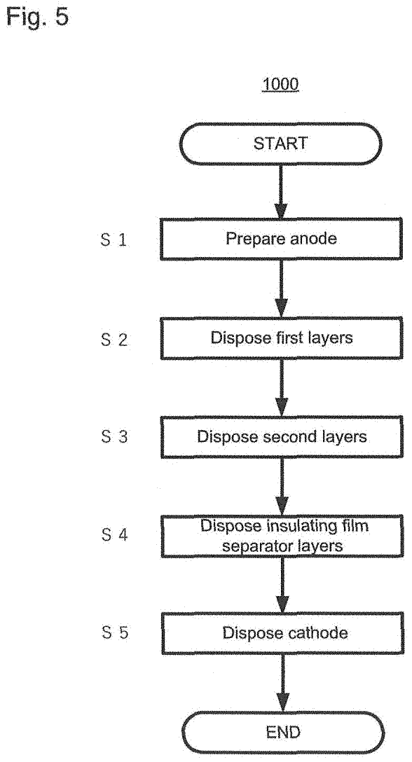

The manufacturing method 1000 is a method of manufacturing a honeycomb type lithium ion battery having an anode, a cathode, and a separator layer. FIG. 5 is a flowchart of the manufacturing method 1000. As in FIG. 5, the manufacturing method 1000 has Steps S1 to S5. Hereinafter each step will be described.

<Step S1>

Step S1 is a step of preparing an anode having a plurality of through holes extending in one direction. The method of preparing such an anode of a honeycomb structure is not particularly limited, but an example thereof is as follows. First, an anode material to constitute the anode is mixed with a solvent (e.g., water) to be a slurry. Next, the slurry is subjected to extrusion molding through a predetermined metal mold, and is heated for a predetermined time to be dry. According to this, the anode can be prepared. Here, the drying temperature is not particularly limited, but is, for example, in the range of 50° C. and 200° C. The drying time is not particularly limited, but is in the range of 10 minutes and 2 hours.

<Step S2>

Step S2 is performed after Step S1, and is a step of covering inner walls of the through holes of the anode with first layers of partition separator layers. The way of the covering with the first layers is as follows. First, a material to constitute the first layers is mixed and kneaded with a solvent (e.g., water) to be a paste. Next, the paste is disposed on one face (opening face part) of the anode in the penetrating direction, and suction is exerted at the opposite face to adhere the paste to the inner walls of the through holes. Subsequently, the anode to which the paste adheres is heated for a predetermined time to be dry. According to this, the inner walls of the through holes can be covered with the first layers. Here, the drying temperature is not particularly limited, but is, for example, in the range of 50° C. and 200° C. The drying time is not particularly limited, but is in the range of 10 minutes and 2 hours.

<Step S3>

Step S3 is performed after Step S2, and is a step of covering the inner walls of the through holes of the anode, which are covered with the first layers, with second layers of the partition separator layers. The way of the covering with the second layers is as follows. First, a material to constitute the second layers is mixed and kneaded with a solvent (e.g., NMP) to be a paste. Next, the paste is disposed on one face (opening face part) of the anode in the penetrating direction, and suction is exerted at the opposite face to adhere the paste to the inner walls of the through holes. Subsequently, the anode to which the paste adheres is heated for a predetermined time to be dry. According to this, the inner walls of the through holes can be covered with the second layers. Here, the drying temperature is not particularly limited, but is, for example, in the range of 50° C. and 200° C. The drying time is not particularly limited, but is in the range of 10 minutes and 2 hours. The paste is more likely to clog the through holes when the second layers are applied than when the first layers are applied. Thus, water may be made to run through, so that the anode is in a wet state just before the second layer is applied.

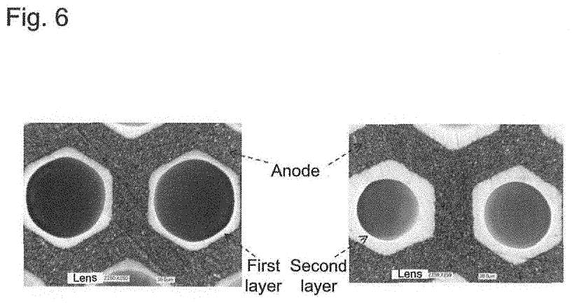

Here, for reference, FIG. 6 shows a photograph (left) of a state where the through holes are covered with the first layers, and a photograph (right) of a state where the through holes are further covered with the second layers.

<Step S4>

Step S4 is performed after Step S3, and is a step of covering the opening face parts of the anode with insulating film separator layers. The method of covering with the insulating film separator layers is not particularly limited, but an example thereof is as follows. First, when adhering to the opening face parts of the anode in Step S3, an excess portion of the partition separator layers is rubbed with sandpaper or the like, so that the opening face parts of the anode are exposed. Next, a material to constitute the insulating film separator layers is put into and is uniformly dispersed across a solution for electrodeposition. Subsequently, a metal tab (e.g., Ni) for electrodeposition is disposed on a side face of the anode. Then, this anode is put into the prepared solution, and a predetermined voltage is applied thereto, so that the material is electrodeposited. After the electrodeposition, the anode is washed with water or the like and is heat-treated at a predetermined temperature. According to this, the opening face parts of the anode can be covered with the insulating film separator layers.

<Step S5>

Step S5 is performed after Step S4, and is a step of disposing the cathode inside the through holes at least via the separator layer (partition separator layers). The way of disposing the cathode is as follows. First, a cathode material to constitute the cathode is mixed and kneaded with a cathode solvent (e.g., NMP, water or the like) to be a paste. The cathode solvent may be suitably selected according to the first layers and the second layers of the partition separator layers, and a binder in the cathode. Next, the paste is disposed on the opening face parts of the anode, which are covered with the partition separator layers. Subsequently, the anode is disposed inside a syringe, and pressure is applied using the syringe to push the paste into the through holes. The resultant is heated for a predetermined time to be dry, whereby the cathode (inner areas) can be disposed inside the through holes, and whereby the cathode (surface areas) can be also disposed on the opening face parts of the anode, which are covered with the partition separator layers. Here, the drying temperature is not particularly limited, but is, for example, in the range of 50° C. and 200° C. The drying time is not particularly limited, but is in the range of 10 minutes and 2 hours. Other than the above described way, the way of disposing the paste on the opening face parts of the anode, and exerting suction at the opposite face to make the material flow into the through holes may be also employed.

When an electrolytic solution is used in the battery to be manufactured, a step of injecting an electrolytic solution all over the inside of the electrode body (specifically, all of the pores of the anode 10, the cathode 20, and the separator layer 30) may be included after the step S5.

The method of manufacturing a honeycomb type lithium ion battery according to the present disclosure has been described using the manufacturing method 1000. The method of manufacturing a honeycomb type lithium ion battery according to the present disclosure makes it possible to manufacture a honeycomb type lithium ion battery that makes it possible to suppress a short circuit.

### EXAMPLES

Hereinafter the present disclosure will be further described using Examples.

### Preparation of Cells for Evaluation

Cells for evaluation according to Examples 1 to 10 and Comparative Examples 1 to 7 were prepared as follows.

### Example 1

### <Preparation of Anode>

A slurry was prepared by mixing of 100 parts by weight of a natural graphite fine particle having a mean particle diameter of 15 μm, 10 parts by weight of carboxy methylcellulose, and 60 parts by weight of ion-exchanged water. Next, the slurry was subjected to extrusion molding through a predetermined metal mold, and was dried at 120° C. for 3 hours. Then the resultant anode was obtained. The anode had a circular cross-sectional shape of 20 mm in diameter, and was provided with a plurality of through holes each having a regular hexagonal shape of 350 μm in side length on this cross section. Any adjacent through holes were arranged at regular intervals. These intervals (rib thicknesses) were 250 μm each. The length of the anode in the penetrating direction was 1 cm.

(Disposing First Layers of Partition Separator Layers)

A paste was prepared by mixing and kneading of 42 parts by weight of a boehmite fine particle having a mean particle diameter of 500 nm, 15 parts by weight of a polyethylene (PE) dispersant (Arrowbase SD-1205J2 produced by UNITIKA LTD., solid content: 25%), and 43 parts by weight of an ion exchanged water. Approximately 3 g to 5 g of this paste was placed on one opening face part of the anode in the penetrating direction, and suction was exerted with a vacuum pump at the opposite opening face part, whereby the paste was adhered to inner walls of the through holes. Next, this anode was dried at 120° C. for 15 minutes, and thus first layers were fixed to the inner walls of the through holes. The thicknesses of the first layers were approximately 35 μm each.

(Disposing Second Layers of Partition Separator Layers)

A paste was prepared by mixing and kneading of 42 parts by weight of a boehmite fine particle having a mean particle diameter of 500 nm, 18 parts by weight of PVDF (#8500 produced by KUREHA CORPORATION), and 40 parts by weight of NMP. Approximately 3 g to 5 g of this paste was placed on one opening face part of the anode in the penetrating direction, and suction was exerted with a vacuum pump at the opposite opening face part, whereby the paste was adhered to inner walls of the first layers. Here, water was made to run through the through holes just before the paste was applied, so that the through holes were in a wet state in order to prevent clogging when the paste was inserted. Then, this anode was dried at 120° C. for 15 minutes, and thus second layers were fixed to the inner walls of the through holes. The thicknesses of the second layers were approximately 35 μm each.

(Disposing Insulating Film Separator Layers)

Both the opening face parts of the anode, where the partition separator layers were disposed, in the penetrating direction were processed so that excess portions of the partition separator layers which were fixed to the surfaces were rubbed with sandpaper and the opening face parts of the anode was exposed.

Subsequently, insulating film separator layers were disposed on the opening face parts of the anode. First, 30 parts by weight of a boehmite fine particle having a mean particle diameter of 100 nm, and 90 parts by weight of ion-exchanged water were put into 25 parts by weight of a PI solution for electrodeposition (Elecoat PI produced by Shimizu co. ltd.) where a polyimide fine particle was dispersed, and were dispersed until uniform. The anode, around a side surface (circumferential side surface) of which a Ni tab was wound in advance, was put into the resultant solution. Next, the separator layers were electrodeposited over the opening faces with a voltage of 15V applied for 2 minutes as the anode side was −and the working electrode side was +. The anode after the electrodeposition was roughly washed with water, so that an excess electrodeposition solution was removed, to be heat-treated at 180° C. for 1 hour. Thus, the insulating film separator layers were disposed on both of the faces of the anode in the penetrating direction. The thicknesses of the insulating film separator layers were approximately 36 μm each.

(Disposing Cathode)

A paste was prepared by mixing and kneading of 94 parts by weight of lithium cobaltate having a mean particle diameter of 10 μm, 5 parts by weight of acetylene black, 1 part by weight of PVDF (#1300 produced by KUREHA CORPORATION), and 30 parts by weight of NMP (cathode solvent). Next, the anode was fixed to the inside of a plastic syringe, 3.5 g of the paste was put into this syringe, and pressure was applied using the syringe, whereby the paste was injected into the through holes. The syringe was stopped being pushed when it was visually confirmed that the paste came out of the opening face part on the opposite side of the injection side. Then, the anode was taken out from the plastic syringe and dried at 120° C. for 30 minutes. According to the foregoing, a cell for evaluation according to Example 1 was prepared.

### Examples 2 to 7

Cells for evaluation according to Examples 2 to 7 were each prepared in the same manner as in Example 1 except that the volume ratio of the binder and the inorganic fine particle (binder/inorganic fine particle) in the first layers was changed as in Table 1.

### Examples 8 to 10

Cells for evaluation according to Examples 8 to 10 were each prepared in the same manner as in Example 1 except that the binder contained in the first layers were changed to polypropylene (PP), and that the volume ratio of the binder and the inorganic fine particle (binder/inorganic fine particle) in the first layers was changed as in Table 1.

### Comparative Example 1

A cell for evaluation according to Comparative Example 1 was prepared in the same manner as in Example 1 except that no second layer was provided.

### Comparative Example 2

A cell for evaluation according to Comparative Example 2 was prepared in the same manner as in Example 1 except that no second layer was provided, and that the composition of the first layers was changed to that of the second layers.

### Comparative Examples 3 to 6

Cells for evaluation according to Comparative Examples 3 to 6 were each prepared in the same manner as in Example 1 except that the volume ratio of the binder and the inorganic fine particle (binder/inorganic fine particle) in the first layers was changed as in Table 1.

### Comparative Example 7

A cell for evaluation according to Comparative Example 7 was prepared in the same manner as in Example 1 except that the composition of the first layers and the composition of the second layers were changed with each other.

### EVALUATION

### Confirmation of Short Circuit

The resistance between the cathode on one side and the anode on a side face in each of the prepared cells for evaluation was measured. When the measured resistance was lower than 1 MΩ, it was determined that the cathode and the anode short-circuited, and when the resistance was at least 1 MΩ, it was determined that the cathode and the anode were insulated. The results are shown in Table 1. “O.L.” in Table 1 indicates that the resistance was beyond the measurement limit (10000 kΩ) of the tester.

### Measuring DC Resistance

Meshed aluminum foil was joined to the cathode of the prepared cell for evaluation via 0.5 g of a paste that is the same as the paste constituting the cathode. The surface of the aluminum foil was used as a cathode current collecting face. Here, the aluminum foil had a circular shape of 25 mm in diameter, and had a thickness of 15 μm. The aluminum foil was in the form of mesh in which there were a plurality of through holes each having a diameter of 1 mm. The proportion of the area of the through holes in the entire surface of the aluminum foil was 40%.

Next, nickel wire was wound around the side face of the cell for evaluation once, and fixed by resistance welding. The nickel wire was 50 μm in thickness and 3 mm in width. The surface of the nickel wire was used as an anode current collecting face.

Next, SUS tabs were welded to both the current collecting faces of the cell for evaluation, and thereafter the cell for evaluation was vacuum-sealed in laminated film. At this time, 5 g of an electrolyte solution (EC:EMC:DMC=1:1:1 and LiPF₆ of 1 mol/kg) was put in the laminated packaging. Thereby a battery for evaluation was obtained.

The following charge and discharge test was carried out on the prepared battery for evaluation. First, the battery was charged under the conditions of: CC at 3.9 V; CV cut at 5 mA; and current rate at 100 mA. Next, a current of 300 mA was passed towards the discharge side for 1 second. The DC resistance was calculated from the voltage drop at this time. The results are shown in Table 1.

TABLE 1

| | First layer | | Second layer | | | | |
|---|---|---|---|---|---|---|---|
| | | Volume ratio | | Volume ratio | Confirmation of short circuit | | DC |
| | | (binder/inorganic | | (binder/inorganic | Resistance | | resistance |
| | Binder | fine particle) | Binder | fine particle) | (kΩ) | Determination | (Ω) |
| Example 1 | PE | 0.28 | PVDF | 0.09 | O.L. | insulated | 5.2 |
| Example 2 | PE | 0.05 | PVDF | 0.09 | 1800 | insulated | 5.0 |
| Example 3 | PE | 18 | PVDF | 0.09 | O.L. | insulated | 6.4 |
| Example 4 | PE | 0.28 | PVDF | 0.05 | 2100 | insulated | 4.8 |
| Example 5 | PE | 0.28 | PVDF | 1.73 | O.L. | insulated | 6.6 |
| Example 6 | PE | 10 | PVDF | 1.5 | O.L. | insulated | 5.4 |
| Example 7 | PE | 0.28 | PVDF | 0.09 | O.L. | insulated | 5.5 |
| Example 8 | PP | 0.28 | PVDF | 0.09 | O.L. | insulated | 4.4 |
| Example 9 | PP | 0.05 | PVDF | 0.09 | 1700 | insulated | 4.3 |
| Example 10 | PP | 18 | PVDF | 0.09 | O.L. | insulated | 5.0 |
| Comparative | PE | 0.28 | — | — | 0.52 | short-circuited | — |
| Example 1 | | | | | | | |
| Comparative | PVDF | 0.09 | — | — | 0.45 | short-circuited | — |
| Example 2 | | | | | | | |
| Comparative | PE | 0.01 | PVDF | 0.09 | 13.4 | short-circuited | — |
| Example 3 | | | | | | | |
| Comparative | PE | 23 | PVDF | 0.09 | O.L. | insulated | 12.5 |
| Example 4 | | | | | | | |
| Comparative | PE | 0.28 | PVDF | 0.01 | 0.81 | short-circuited | — |
| Example 5 | | | | | | | |
| Comparative | PE | 0.28 | PVDF | 2.2 | O.L. | insulated | 15.3 |
| Example 6 | | | | | | | |
| Comparative | PVDF | 0.09 | PE | 0.28 | 11.2 | short-circuited | — |
| Example 7 | | | | | | | |

### RESULTS

In Examples 1 to 10, a short circuit between the cathode and the anode was suppressed, and good DC resistance was shown. In contrast, in Comparative Examples 1 to 3, 5 and 7, a short circuit was not suppressed. This is believed to be because: each of the partition separator layers was only one layer in Comparative Examples 1 and 2; the volume ratio of the binder in the first layers was too low in Comparative Example 3; the volume ratio of the binder in the second layers was too low in Comparative Example 5; and the relationship between the solubility of the binders used in the first layers and that in the second layers, in the cathode solvent (NMP) was the inverse of those in the other Examples, and cracks, pin holes, etc. were generated in Comparative Example 7. In Comparative Examples 4 and 6, no short circuit occurred but a large value of the DC resistance was shown. This is believed to be because the volume ratio of the binder in the first layers was too high in Comparative Example 4 and because the volume ratio of the binder in the second layers was too high in Comparative Example 6.

### REFERENCE SIGNS LIST

10 anode

20 cathode

21 inner area

22 surface area

30 separator layer

31 partition separator layer

31a first layer

31b second layer

32 insulating film separator layer

40 anode current collector

50 cathode current collector

100 honeycomb type lithium ion battery

What is claimed is:

1. A honeycomb type lithium ion battery having an anode, a cathode, and a separator layer,
wherein the anode has a plurality of through holes extending in one direction,
the separator layer has Li ion permeability, and physically isolates the anode and the cathode from each other, at least inner walls of the through holes being covered with the separator layer,
the cathode is disposed at least inside the through holes via the separator layer,
the separator layer has a first layer with which the inner walls of the through holes are covered, and a second layer disposed between the first layer and the cathode, and
solubility of a binder contained in the first layer, in a solvent used when the cathode is disposed in the through holes is lower than that contained in the second layer.
